(19) United States
(12) Patent Application Publication
(10) Pub. No.: US 2015/0336204 A1
(43) Pub. Date: Nov. 26, 2015

(54) JOINING PROCESS FOR NEUTRON ABSORBING MATERIALS

(71) Applicant: HOLTEC INTERNATIONAL, INC., Marlton, NJ (US)

(72) Inventors: Krishna P. Singh, Hobe Sound, FL (US); Joseph Albert Meckley, Marlton, NJ (US); Laszlo Zsidai, Voorhees, NJ (US)

(21) Appl. No.: 14/655,897

(22) PCT Filed: Dec. 27, 2013
(86) PCT No.: PCT/US13/77979

§ 371 Date: Jun. 26, 2015

Related U.S. Application Data
(60) Provisional application No. 61/746,294, filed on Dec. 27, 2012.

(51) Int. Cl. B23K 20/12; B23K 20/233

(52) U.S. Cl. CPC B23K 20/122; B23K 20/2333

(57) ABSTRACT

A method and associated system for joining workpieces formed of neutron absorbing materials. The method includes positioning first and second workpieces together to form a joint, heating the first and second workpieces at the joint to a plastic condition, intermingling plastic material from the first and second workpieces together at the joint, and cooling the intermingled plastic material to a solid state forming a welded fusion zone comprised of material from the first and second metal matrix composite workpieces. The workpiece material at the joint is not melted by the heating. The heating may be perforated by frictionally heating the materials with a rotary tool, in one non-limiting embodiment, the neutron absorbing workpieces may be formed of metal matrix composites comprising aluminum or aluminum alloy and boron carbide.

### CROSS-REFERENCE TO RELATED APPLICATIONS

The present application claims the benefit of U.S. Provisional Patent Application Ser. No. US 61/746,294 filed Dec. 27, 2012, which is incorporated herein by reference in its entirety.

### FIELD OF THE INVENTION

The present invention relates to material joining processes, and more particularly to a welding process suitable for joining materials usable in the nuclear power generation industry having neutron absorbing properties.

### BACKGROUND OF THE INVENTION

Metal matrix composites (MMCs) made with aluminum or aluminum alloy powder mixed with embedded particles of boron carbide have become quite popular neutron absorber materials in the nuclear power industry because of their essentially porosity-free body and their ability to hold a large percentage of boron carbide (a neutron poison). For example, Metamic disclosed in U.S. Pat. No. 6,042,779, incorporated herein by reference in its entirety, is routinely manufactured with boron carbide loadings in excess of 32% by weight. A newer nano-particle based. MMCs called Metamic-HT (see U.S. Pat. No. 8,158,962, incorporated herein by reference in its entirety) maintains excellent strength properties at elevated temperatures, making it a suitable structural as well as neutron absorber material. Both Metamic and Metamic-HT are examples of MMCs that are being successfully used in the nuclear power industry for neutron attenuation purposes.

The most common application of MMCs is in the so-called “fuel basket” used to store used nuclear End in a dry storage cask. The MMCs, however, suffer from a serious limitation—lack of weldability—which has prevented designers from fully exploiting their potential in designing compact nuclear fuel storage devices. Because the MMCs could not heretofore be joined by welding, they must be held in place by a weldable support material, such as for example stainless steel. This is an unsatisfactory aspect of the state of the art for several reasons, including: (1) the thermal conductivity of the fuel basket is reduced by the presence of stainless steel; and (2) stainless steel occupies valuable cross section space where the boron bearing MMC would be, thus reducing the overall neutron capture capability of the fuel basket.

There have been attempts to create a monolithic MMC basket design that relies on strength joining of the MMC panels to themselves. Unfortunately, tests show that welding by classical MIG or TIG processes fails to produce a high quality joint, which is attributed to the boron carbide particles situated on the grain boundaries in the MMC plates. A joining method that produces a high strength butt or corner joint is evidently critical to the manufacturing of a monolithic MMC basket.

### SUMMARY OF THE INVENTION

The present invention provides a process and apparatus whereby as Metal Matrix Composite (MMC) material may be joined to itself or other material such as without limitation aluminum, to form a uniform, or near uniform, cross section of composite material by means of mechanical stirring in the plastic state. Accordingly, embodiments of the present invention provide a system of tooling, fixturing, and particular operating parameters whereby the MMC material (e.g. Metamic. or Metamic-HT) components or parts ma v be joined to other MMC components or parts, or in some embodiment to other non-boron containing materials such as without limitation aluminum for example. In certain embodiments, this may be done with or without the use of pre-placed filler material in the joints.

The joining process may use a specially designed tool as further described herein that applies pressure while simultaneously melting and stirring the MMC material in the plastic state by using unique operating parameters, fixturing, and optionally tiller materials in such a manner as to produce weld joints which are themselves comprised of the MMC material of at least similar strength and ductility as the parent material. In some embodiments, the weld joint has greater strength that the metal matrix composite base materials.

According to one exemplary embodiment, a method for joining neutron absorbing materials together includes: providing a first and second metal matrix composite workpiece each comprising a neutron absorbing material; positioning, edges of the first and second metal matrix composite workpieces together to form a joint; heating the first and second metal matrix composite workpieces at the joint to a plastic condition; intermingling plastic material from the first and second metal matrix composite workpieces together at the joint; and cooling the intermingled plastic material to a solid state farming a welded fusion zone comprised of material from the first and second metal matrix composite workpieces, wherein the first and second metal matrix composite workpieces are fused together at the joint.

According to another exemplary embodiment, a method for welding neutron absorbing materials together includes: providing a first and second metal matrix composite workpiece each comprising material including boron carbide; positioning edges of the first and second metal matrix composite workpieces together to form as joint; frictionally heating joining portions of the first and second metal matrix composite workpieces at the joint to a plastic condition, wherein the joining portions are not melted by the frictional heating; intermingling plastic material from the first and second metal matrix composite workpieces together at the joint; and cooling the intermingled plastic material to a solid state farming a welded fusion zone comprised of material from the first and second metal matrix composite workpieces, wherein the first and second metal matrix composite workpieces are fused together at the joint.

According to another exemplary embodiment, a method for welding neutron absorbing materials together includes: providing a first and second metal matrix composite workpiece each comprising a neutron absorbing material; providing a rotary tool having a head configured to engage the first and second metal matrix composite workpieces; positioning edges of the first and second metal matrix composite workpieces proximate to each other to form a joint; rotationally engaging the first and second metal matrix composite workpieces at the joint with the had of the rotary tool, frictionally heating the first and second metal matrix composite workpieces at the joint to a plastic condition with the rotating head of the rotary tool, wherein the joining portions of the first and second metal matrix composite workpieces are not melted, by the frictional heating; intermingling plastic material from the first and second metal matrix composite workpieces together at the joint; and cooling the intermingled plastic material to a solid state forming a welded fusion zone comprised of material from the first and second metal matrix composite workpieces; wherein material of the first and second metal matrix composite workpieces at the joint are heated to a temperature between and including 400 to 1000 degrees Fahrenheit. In one embodiment, an interface of the first and second metal matrix composite workpieces at the joint is subjected to pressure in the range of approximately 20-60% of the yield strength of the metal matrix composite material by the rotary tool during the welding process.

### BRIEF DESCRIPTION OF THE DRAWINGS

The features of the exemplary embodiments of the present invention will be described with reference to the following drawings, where like elements are labeled similarly, and in which:

FIG. 1A is an elevation view of a butt joint in accordance with an embodiment of the present invention;

FIG. 1B is a three-dimensional perspective view of the butt joint of FIG. 1A;

FIG. 2A is an elevation view of a corner joint M accordance with an embodiment of the present invention;

FIG. 2B is a three-dimensional perspective view of the corner joint of FIG. 2A;

FIG. 3A is an elevation view of a corner joint with fillet in accordance with an embodiment of the present invention;

FIG. 3B is a three-dimensional perspective view of the corner joint with fillet of FIG. 3A;

FIG. 4A is an elevation view of a socket type joint in accordance with an embodiment of the present invention;

FIG. 4B is a top plan view thereof;

FIG. 4C is a three-dimensional perspective view of the socket type joint of FIG. 4A;

FIG. 5 is a general side cross-sectional view of a joining tool in accordance with an embodiment of the present invention making a weld joint between two adjoining workpieces.

FIG. 6 is a three dimensional illustration of the tool of FIG. 5 in motion during formation of a butt weld such as in FIG. 1A;

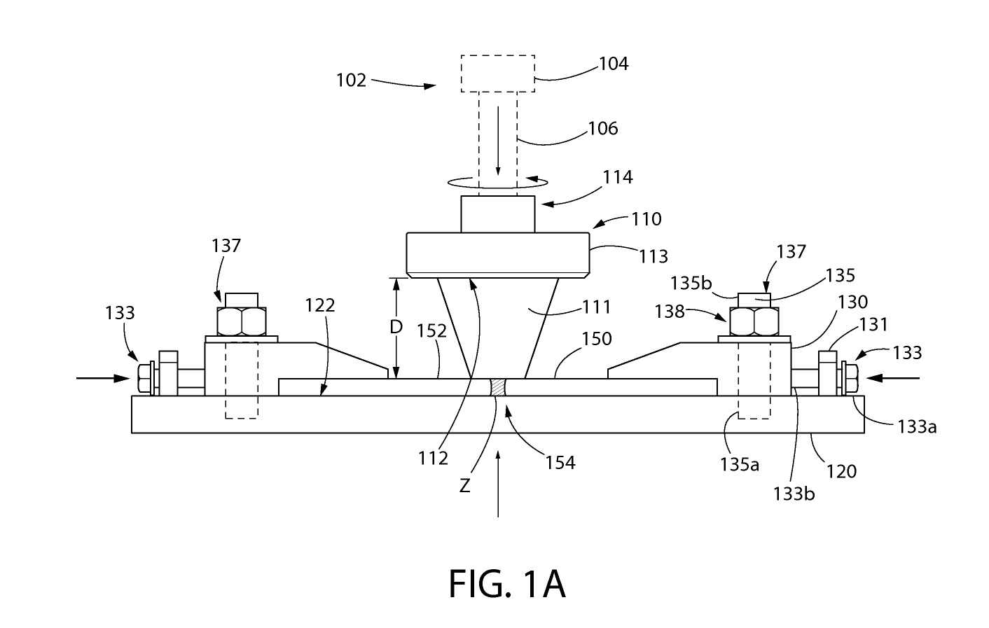

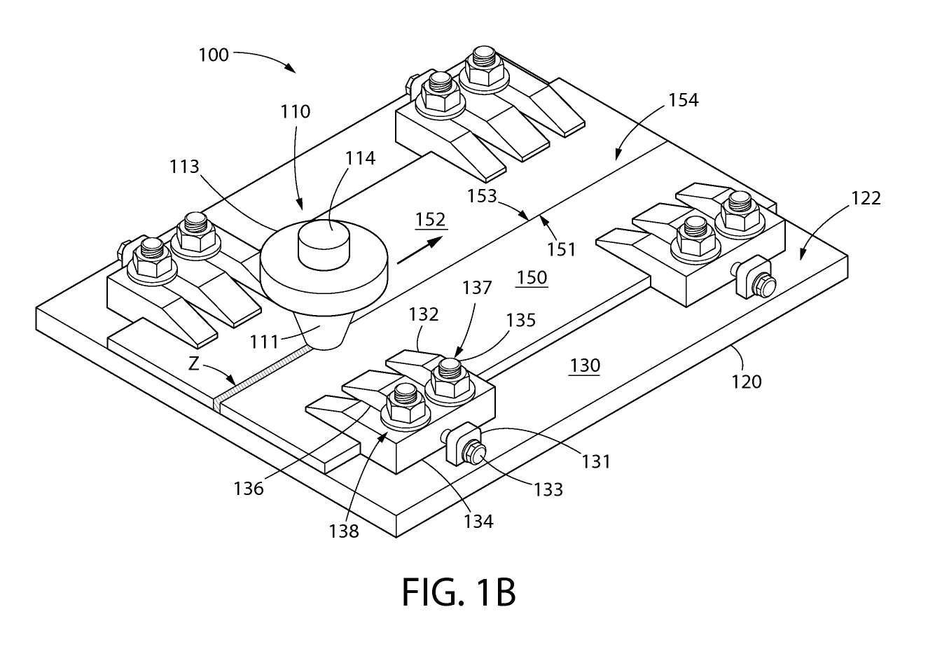

All drawings are schematic and not necessarily to scale. Parts given a reference numerical designation in one figure may be considered to be the same parts where they appear in other figures without a numerical designation for brevity unless specifically labeled with a different part number and described herein. References herein to a figure number (e.g. FIG. 1) shall be construed to be a reference to all subpart figures in the group (e.g. FIGS. 1A, 1B) unless otherwise indicated.

### DETAILED DESCRIPTION OF THE EMBODIMENTS

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof g “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

A new joining method for MMC plates is provided in one embodiment that relies on simultaneous application of substantial axial pressure at the intended joint interface along with frictional heating of the interface by a rotating tool which generates heat by friction effects while actuating a plastic mixing of the material in the two bodies. The temperature of the plasticized mass is maintained to below 85% of the melting point of the base metals being joined which advantageously eliminates the undesirable effect of migration of the boron carbide particles from the grain boundaries. Low joining temperature also protects the parts from heat induced distortion. In its fundamental aspects this present joining process may be classified as a derivative of “friction stir welding” (FSW), a term of art that has taken hold in the literature even though it lacks a basic attribute of welding, namely melting and resultant coalescence of the base materials to join the base materials together at the joint interface. Friction stir welding is a solid-state joining process Which does not melt the workpiece metal and uses a rotary non-consumable tool to instead soften the adjoining metal to be joined by generating frictional heating, The metal is softened to a plastic state and coalesced from each MMC plate at the interface to join and fuse to join or fuse the workpieces.

The present MMC joining process can be used to make full penetration, partial penetration, fillet, and socket welds utilizing different joint designs (for example butt joint, tee joint, corner joint, edge joint) as shown in the FIGS. 1, 2, 3, 4, and 5 (inclusive of all subparts). In addition to using the present joining, process and apparatus to join MMC material in a variety of joint configurations using components of the same, the process and apparatus may further be used to join MMC to another type of non-boron metal such as without limitation aluminum or other metals, in some embodiments, pre-laced filler material may also be placed strategically in the joint to provide added strength, shielding, structural integrity, or component shape.

The present process and apparatus produces a joint which can be non-destructively evaluated with conventional methods such as radiography, and which achieves similar mechanical properties to the original base MMC material.

In exemplary embodiments, the equipment used in a joining system for joining MMC materials may include a commercially available friction stir welding (FSW) or milling machine equipped with special tooling, special robust fixturing, and special process parameters to account for the unique properties of the MMC material. In one embodiment, without limitation, the special tooling may include a rotating joining tool powered by the FSW or milling machine, as further described herein.

FIGS. 1 and 1A depict an exemplary joining system 100 and equipment setup configured for making a butt joint. The system 100 generally includes rotary joining tool 110 powered by a motorized rotary machine 102 and a base 120 for supporting workpieces 150 and 152 to be joined together. In one embodiment, the workpieces 150, 152 may be comprised of a metal matrix composite base material containing a neutron absorbing material such as particles of boron carbide. In some non-limiting exemplary embodiments, workpieces 150, 152 may be a compound made of aluminum or aluminum ahoy mixed with embedded particles of boron carbide.

Rotary tool 110 is configured and operable to frictionally heat the workpieces 150, 152 to a sufficient temperature and plastic state along the interface for joining by friction stir welding (FSW). The rotary machine 102 includes an electric (or other power driven) motor 104 which drives a spindle or shall 106 coupled to and operable to impart rotational motion to the rotary tool 110. In addition to imparting rotary motion to tool 110, rotary machine 102 is further operable to create an axial three acting along shaft 106 (e.g. via hydraulic force rams, etc.) to force the tool 110 against the workpieces 150, 152 at the joint 154 with sufficient force and pressure for creating frictional welding pressure to join and fuse the workpieces.

Referring to FIGS. 1A, 1B, 5, and 6, rotary tool 110 may have a circular shape in top plan view and generally includes a head 113 having a rotating round shoulder defining a bottom and downward facing terminal end surface 112 configured fix abuttingly engaging surfaces of the metal matrix composite workpieces 150,152 during the welding process. The shoulder end surface 112 of tool head 113 may have any suitable transverse cross-sectional shape in side profile, including flat (see, e.g. FIG. 1A), angled, concave, convex, or other. End surface 112 assists with forming the outer profile of the finished weld by guiding and pooling the plasticized metal matrix composite base material during welding. Head 113 may have any suitable diameter and shape, including cylindrical as shown in FIGS. 1A and 1B or other.

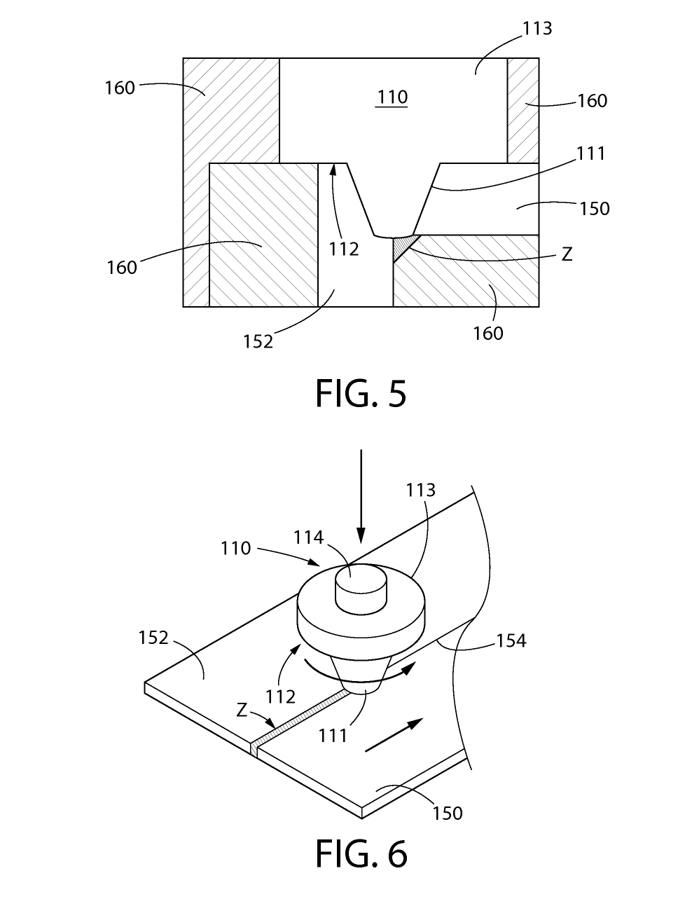

Head 113 may further include a welding, probe (protrusion) such as a tool pin 111 that projects axially outwards from terminal end surface 112 into the stirring zone in the joint 154 during the frictional welding process (see, e.g. FIG. 5). The tool pin 111 heats the workpieces via, friction and moves or stirs the softened plastic state workpiece base material around in the fusion zone Z at joint 154 to form the welded joint. Accordingly, tool pin is preferably fully inserted into joint 154 (see, e.g. FIG. 5) such that the end surface 112 on the underside or bottom of head 113 abuts the surfaces of workpieces 150, 152 adjacent the joint 154 (i.e. “joining portions”). Tool pin 111 has an axial length defining a plunge depth as illustrated in FIG. 1A measured from the terminal tip of pin 111 to end surface 112 of the tool head 113.

It should be noted that in the drawings other than FIG. 5, the tool pin 111 is shown for convenience above the workpieces 150, 152 before being plunged into the joint 154 (see, e.g. FIGS. 1A, 1B, etc.) to not obscure details of the joint being described. Therefore, it is understood that during the friction stir welding (FSW) process, the tool pin 111 would normally he positioned between the workpieces 150, 152 and inserted in joint 154 with the bottom end surface 112 of tool head 113 contacting and traversing the opposing workpiece surfaces along the joint. The weld joint formed may therefore have a width and side profile that essentially complements that of the tool pin 111. In some partially ems, the tool pin 111 may be partially plunged into the joint 154 during the FSW process.

Tool pin 113 may have any suitable geometry or configuration, including without limitation cylindrical, tapered, conical, frustoconical, or other. Although tool pin 113 may be shown with a frustoconical shape herein, it is expressly understood that the invention is not limited in this respect. Tool pin 113 may further be fluted or threaded in some embodiments.

Rotary tool HO may be detachably coupled at a mounting end 114 to rotating shall 106 of rotary machine 102 by any suitable locking means so that the tool rotates in unison with the rotary machine shaft. Rotary tool 110, particularly head 113 and pin 111 may be made of a suitable metal used in the art for friction stir welding, such as without limitation steel or steel alloy which is commonly used.

With continuing reference to FIGS. 1 and 1A, the base 120 may have various configurations and sizes depending on the final configuration of the joined workpieces to be completed. One or more bases 120 may be provided as needed and arranged in any suitable orientation and relationship to hold the workpieces 150, 152 in proper position to accomplish the intended material joint configuration.

One or more movable and adjustable fixture Clamps 130 may be provided Which are configured and operable to tightly hold workpieces 150, 152 together during the joining or fusing process. Clamps 130 may be movably affixed to the base 120 in one embodiment for linear movement in opposing directions to lock and unlock workpieces 150, 152 from the base. In one embodiment, each clamp 130 includes jaws 132 configured for gripping workpieces 150, 152 and an adjoining base portion 134 configured for slidably engaging the top surface 122 of base 120 in some arrangements. Clamps 130 may have a stepped side profile with jaws 132 being vertically spaced apart from top surface 122 of base 120 forming a gap for receiving a portion of a workpiece 150, 152 therein.

In one embodiment, jaws 132 may include one or more parallel elongated slots 136 which are arranged perpendicular to the joint 154 formed between the two abutted workpieces 150, 152. Each slot 136 may receive a portion of a threaded locking fastener 137 therethrough which is vertically adjustable (as oriented in FIG. 1) in relation to the top surface 122 of base 120 to lock the clamp in horizontal position with respect to base 120 and workpieces 150, 152. Accordingly, fasteners 137 are vertically oriented and perpendicular to top surface 122 of base 120 (as depicted in FIG. 1).

In one exemplary non-limiting embodiment, the threaded fasteners 137 may comprise a threaded stud 135 having a mounting end 135a engaged with base 120 and an opposite free end 135b receiving a combination nut and washer assembly 138 thereon as shown. The mounting end 135a of stud 135 may be rigidly attached to base 120 in one embodiment so as to not rotate when threading the nut and washer 138 onto the stud. In other possible embodiments, the threaded fasteners 137 may be machine bolts such as a hex head bolt with end 135a engaging a threaded socket formed in base 120. Either of the foregoing fastener arrangements or other types of fasteners, or others may be used. The fasteners 137 remain stationary in horizontal position with respect to base 120 and clamps 130.

With continuing reference to FIGS. 1 and 1A, base 120 may further include fixedly attached lugs 131 having a threaded through hole receiving a threaded tightening fastener 133 therethrough. Lugs 131 extend vertically upwards from top surface 122 of base 120 and may have any suitable configuration. In one non-limiting exemplary embodiment, fastener 133 may be a machine bolt such as a hex bead bolt having a head 133a on one end and an opposite end 133B abuttingly engaging base portion 134 of clamp 130. Fasteners 133 are horizontally oriented (e.g. parallel to top surface 122 of base 120) and arranged perpendicular to fasteners 137. The fasteners 133 are operable via rotating or turning the fasteners to push clamps 130 towards joint 154 between workpieces 150, 152 in order to apply compressive force acting in a horizontal direction against the workpieces and joint. Joint 154 may therefore be placed under lateral pressure using tightening fasteners 133.

In operation, workpieces 150, 152 may Be tightly and releasably attached to base 120 by loosening locking fasteners 137 and inserting a portion of the workpieces beneath a portion of the jaws 132 as shown in FIGS. 1 and 1A. The position of jaws 132 may be adjusted horizontally back and forth in opposing linear directions by sliding the jaws so that the fasteners 137 move through the slots 136. The position of jaws 132 may be adjusted vertically by loosening or tightening the fasteners 137 by an appropriate amount. Once jaws 132 are approximately in the proper position, the fasteners 137 are preferably loosely tightened to allow sonic horizontal movement of the clamp 130. The adjusting fasteners 133 are then rotated by a sufficient amount to move the move the clamps 130 horizontally towards joint 154 between the workpieces 150, 152. Horizontally opposing pairs of clamps 130 are preferably adjusted sufficiently using fasteners 133 to apply a horizontal compressive force or pressure at joint 154 between the workpieces 150 and 152. When this is accomplished and the desired horizontal positional adjustment of clamps 130 is complete, locking fasteners 137 may then be securely tightened to apply a vertical force on the workpieces 150, 152 and maintain the compressive force to keep the workpieces in abutted contact for welding.

It will be appreciated that other means for clamping workpieces 150 and 152 in position for joining and fusing may be used. Accordingly, the invention is not limited to the clamping arrangement disclosed herein which illustrates one or many possible approached for rigging the workpieces.

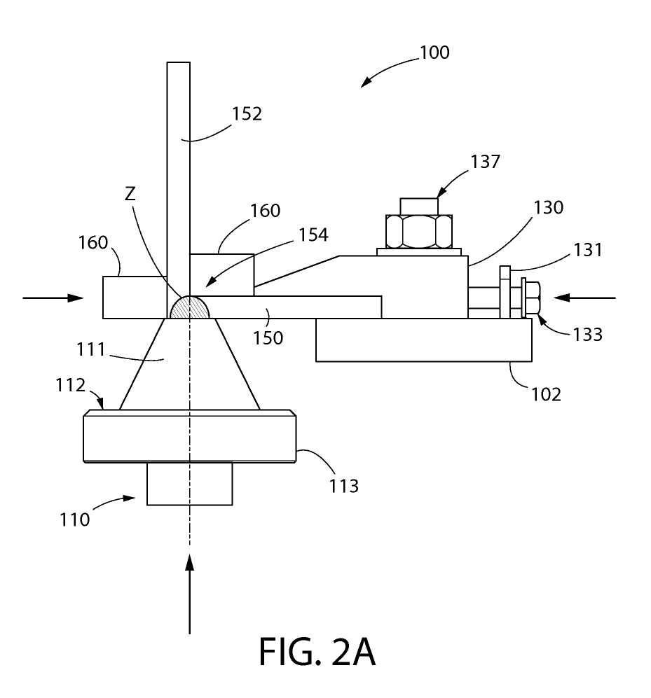

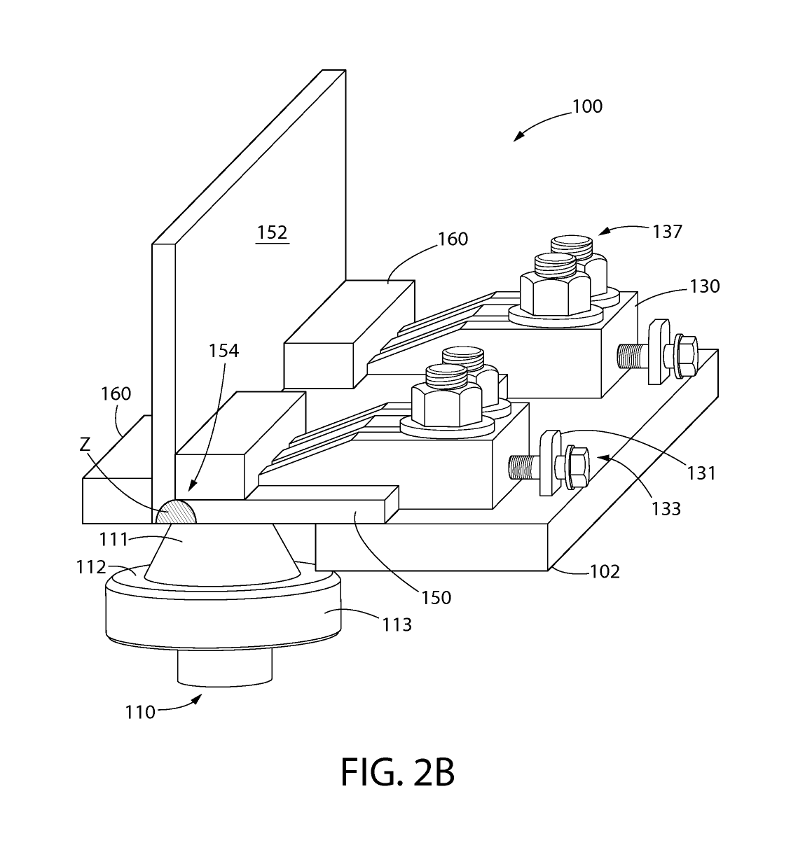

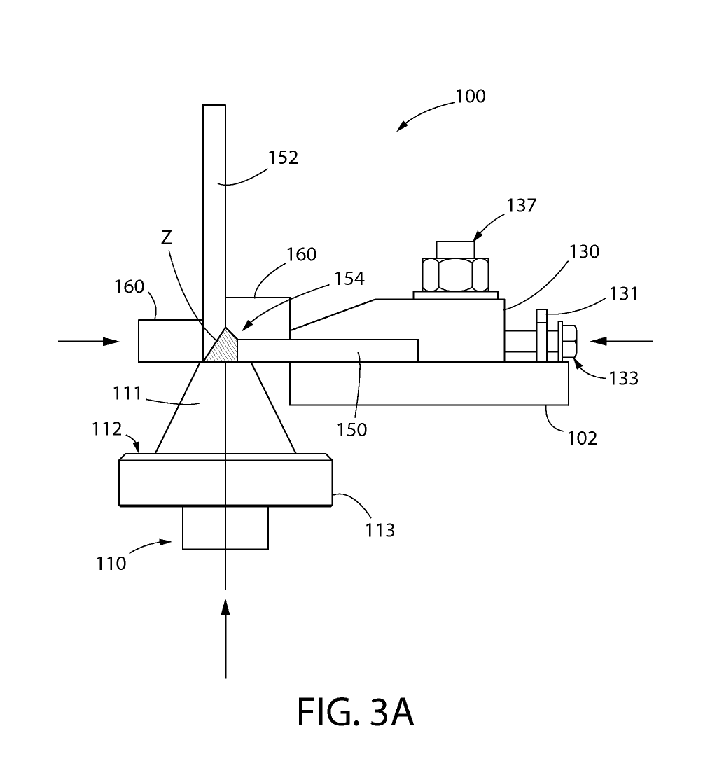

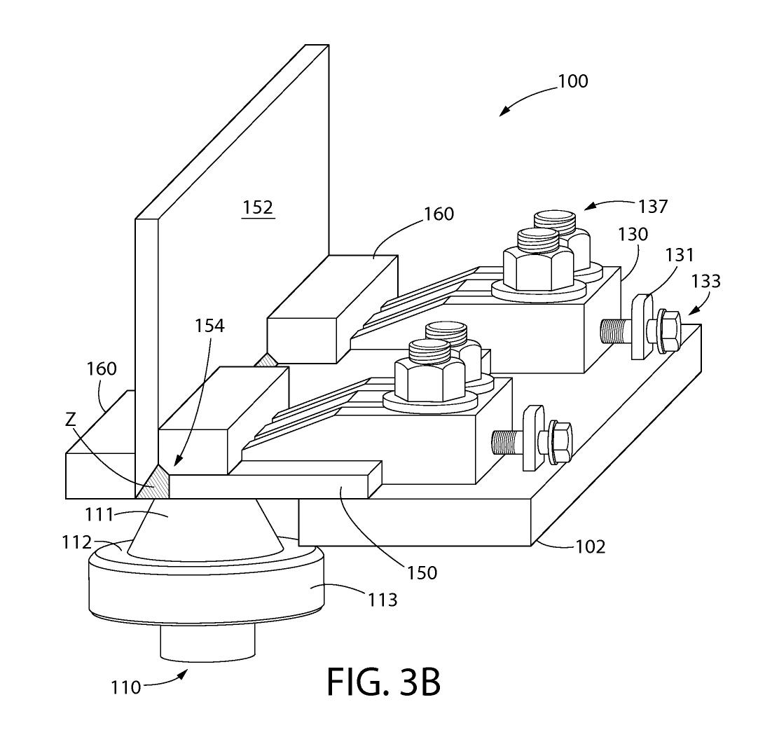

As shown for example in FIGS. 2 and 3 (inclusive of all subparts), one or more fixture supports 160 may be provided to help temporarily hold workpieces 150, 152 in proper position for friction stir welding. Fixture supports 160 may be used separately or in conjunction with clamps 130 to support the workpieces. The workpieces 150, 152 may have any configuration or shape to form a joint 154 of any suitable shape amenable to friction stir welding. In some embodiments, joint 154 may be linear in shape extending in a single direction, or rectilinear or polygonal comprised of two or more linear joint segments extending in two of more orthogonal and/or oblique directions. In yet other embodiments, joint 154 may be non-polygonal or non-linear in shape (e.g. circular, oval, etc.). Any combination of the foregoing joint shapes may be used.

In some embodiments as shown in FIGS. 1-3 (inclusive of all subparts), the workpieces 150 152 may each be substantially flat plates having opposing major surfaces. The workpiece plates may be .arranged and oriented in any manner relative to each other. In FIGS. 1A-B, the workpiece plates may be arranged substantially parallel to each other. In other embodiments as shown in FIGS. 2A-B and. 3A-B, the workpiece plates may be arranged at an angle to each other between 0 and 180 degrees. In some embodiments, the angle may be about 90 degrees as shown where a square edge metal matrix composite component is to be created by friction stir welding.

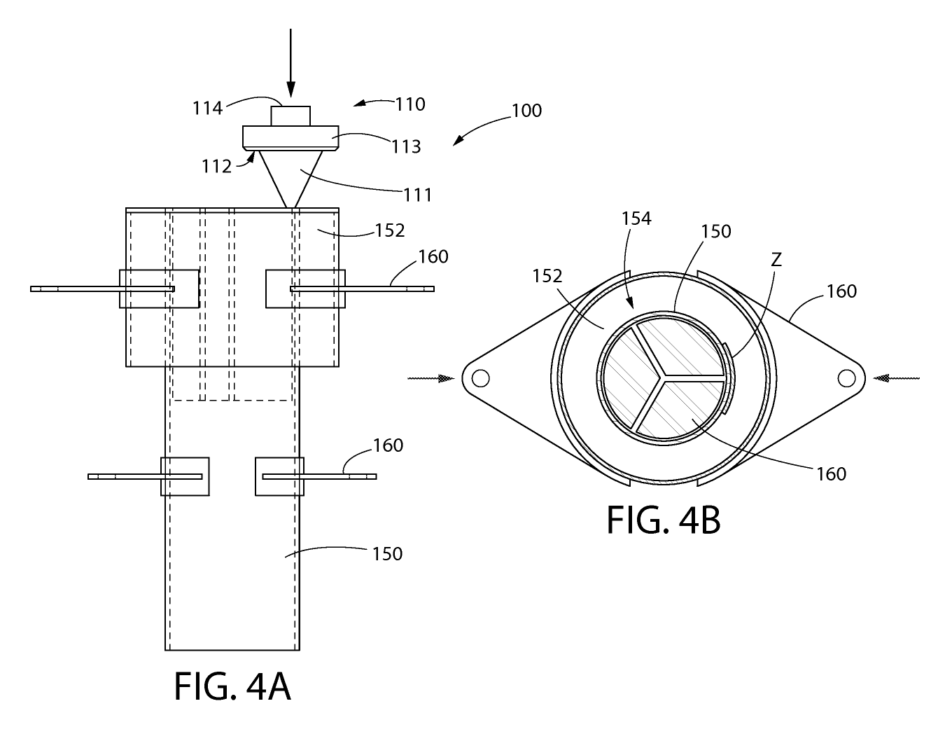

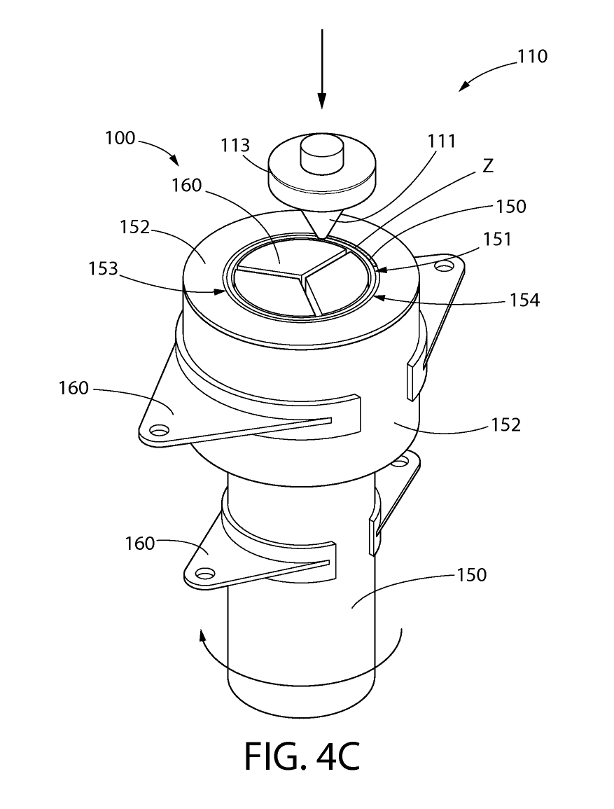

It will be appreciated that various shapes of workpieces 150, 152 may be used and joined via FSW other than the plate forms shown which represent some non-limiting configurations. For example, as shown in FIGS. 4A-C, a socket weld may be produced using workpieces 150, 152 having tubular forms that are joined together at a common end. In this embodiment, workpiece 150 may form an inner member which is axially inserted into workpiece 152 which forms an outer member. The joint 154 in this example is circular, as opposed to linear in the examples shown in FIGS. 1-3. It should further be noted that in some embodiments, both tubular workpieces 150, 152 may be rotated in unison instead of or in addition to rotating the rotating tool 110 during the FSW process.

A method for joining neutron absorbing, materials together such as without limitation metal matrix composite workpieces will now be described in the following friction stir welding (FSW) process. In some embodiments, the workpieces may be aluminum matrix composites including boron carbide.

First and second metal matrix composite workpieces 150, 152 each comprising a neutron absorbing material are provided. The workpieces are then articulated and securely held in the desired position for FSW with an appropriate welding setup assembled using a combination of bases 120, clamps 130, and fixture supports 160 described herein. The fixtures are of adequate size and robust in nature as to apply even, steady pressure on the part, not allowing material movement or expansion during the joining process. FIGS. 1-4 (inclusive of subparts A and B) show various exemplary welding setups for creating different types and configurations of welded joints. The fixture placement and accompanying applied pressure direction to workpieces 150, 152 created are shown by directional arrows. Other arrangements are possible to create other types and configurations of welded joints.

The edges 151, 153 of the two workpiece materials 150, 152 respectively to be joined are positioned proximate to each other (see, e.g. FIGS. 4A-C), and in some embodiments may be abutted together as shown in FIGS. 1-3. Preferably, the edges 151, 153 are at least close enough to allow the plastic state metal matrix composite base material to intermingle during the FSW process for fusing. The abutting edges may be as cut (rough) or ground, and may be anodized, but preferably otherwise are not coated to provide good weld quality. No fluxing agent of an kind or any special atmosphere is generally required for friction stir welding.

The FSW process will now continue to be described with reference to FIGS. 1A-B for convenience, recognizing that the same methodology and process applies to the joint configurations shown in FIGS. 2-4.

The rotating rotary tool 110 is axially advanced (i.e. parallel to the rotary machine shaft 106) into contact with the joining portions of workpieces 150, 152 (defined as the portions of the workpieces at and adjacent to edges 151, 153 along joint 154). Tool pin 111 slowly enters into a part of the joint 154 while rotating, preferably until bottom end surface 112 abuttingly contacts the exposed surfaces of the workpieces adjacent joint 154 (see FIGS. 1A and 1B). The rotating tool head 113 and tool pin 111 heats the metal matrix composite workpiece 150, 152 base materials by friction to the desired joint temperature. The rotary tool head 113 will be traversed along the interface discontinuity at joint 154 generating heat while the joint is under pressure. The interface that is intended to he joined (i.e. edges 151, 153 of workpieces 150, 152) is preferably subjected to pressure in the range of approximately 20-60% of the yield strength of the MMC material at the target joint temperature. The advancing speed of the tool 110 along the joint and rotational speed of the tool is adjusted to ensure that the joint temperature lies in the approximate range of about and including 400 to 1000 degrees Fahrenheit (for neutron absorbing aluminum MMCs with boron carbide). It should be noted that the tool 110 material and specific designs may be specially developed for the specific metal matrix composite material, joint type, and depth of penetration into the material desired for the weld joint to be made.

In the joining and fusing of workpieces 150, 152 together, the rotary machine 102 is generally operated to bring the rotary tool 110 to the starting revolutions per minute (RPM's) before initially plunging the tool into the joint 154 and workpieces, or alternatively a sacrificial “start area” provided (extra material or a temporary start tab which may later be severed from the workpieces after welding). After contact is made with the joint and workpieces, the process continues by then holding the position of rotating tool 110 stationary with respect to the joint for a set delay time (hold time) sufficient to raise the temperature of and bring the workpiece material to the plastic state (e.g. approximately 10 seconds as a non-limiting example). The delay time may vary depending on the material of the workpieces 150, 152, depth of weld to be formed, and other process parameters. The weld pressure is gradually applied at this time by tool 110 and will be sustained during the entire FSW process to maintain a plastic condition of the workpieces 150, 152 base materials at the joint interface. Once the plastic material state is reached, the tool 110 may then be progressed and translated gradually forward along the joint 154 for the desired length of weld to be created at a specific welding speed suitable to properly convert the workpiece base material to a plastic state for proper weld formation. It is well within the ambit of those skilled in the art to determine a proper rate of speed for advancing the rotary tool 110 along the joint 154.

During the FSW process, plastic base material from workpieces 150, 152 in the weld fusion zone Z created at joint 154 will intermingled or stirred by tool pin 111, thereby coalescing and forming a weld comprised of material from each workpiece. As the rotary tool 110 advances along the weld joint 154, the intermingled plasticized material in the weld fusion zone Z behind the tool will cool and harden, thereby permanently joining the workpieces together along their respective edges 151, 153. The two workpieces 150, 152 are welded together at the joint forming a unitary monolithic structure and cannot be separated without the use of destructive means (e.g. mechanical or torch cutting, grinding, etc.).

In some embodiments, a sacrificial “run off tab” may be provided where the tool 110 pressure can be then relieved and the tool may be extracted from the weld joint and workpieces 150, 152. The run off tab is not part of the weld or workpieces intended to be retained in the final component Or part formed by FSW.

It should be noted that the metal matrix composite workpiece material never reaches the melting temperature during the FSW process, only a sufficient elevated temperature combined with sufficient force to bring the material into a plastic state for joining and fusing. Advantageously, the weld may have a mechanical strength at least the same as or greater than the base materials of the workpieces 150, 152 joined. It will be appreciated that the FSW process may be performed with rotary tool 110 in any suitable orientation or position needed to make the weld. Further, the FSW process may be controlled by a properly programmed processor-controlled rotary machine 102.

Numerous types of welds may be formed using the foregoing FSW process. FIGS. 1A-B show a welding setup for making a butt weld. FIGS. 2A-B show a welding setup for making a corner joint weld. FIGS. 3A-B show a welding setup for making a corner fillet weld. And FIGS. 4A-C show a welding setup for making a socket weld.

FIG. 5 is a detailed cross-sectional view of a weld joint being formed with rotary tool 110 in the welding position. The rotary tool 110 in motion during, the FSW process is shown in FIG. 6 with the axial force, rotation, and welding movement along joint 154 shown by the directional arrows provided.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A method for joining neutron absorbing materials together, the method comprising:
providing a first and second metal matrix composite workpiece each comprising a neutron absorbing material;
positioning edges of the first and second metal matrix composite workpieces together to form a joint;
heating the first and second metal matrix composite workpieces at the joint to a plastic condition;
intermingling plastic material from the first and second metal matrix composite workpieces together at the joint; and
cooling the intermingled plastic material to a solid state forming a welded fusion zone comprised of material from the first and second metal matrix composite workpieces,
wherein the first and second metal matrix composite workpieces are fused together at the joint.

2. The method according to claim 1, wherein the first and second metal matrix composite workpieces at the joint are heated to a temperature between and including 400 to 1000 degrees Fahrenheit.

3. The method according to claim 1, wherein the first and second metal matrix composite workpieces at the joint are heated frictionally to the plastic condition.

4. The method according to claim 3, wherein the frictional heating is created by a rotary tool engaging the first and second metal matrix composite workpieces at the joint with sufficient force to form the plastic condition in the joining portions.

5. The method according to claim 4, wherein the rotary motion tool includes a tool pin having a conical or frustoconical shape which engages the joint during the heating step.

6. The method according to claim 4, wherein the rotary tool rotationally engages the first and second metal matrix composite workpieces at the joint to create the frictional heating.

7. The method according to claim 6, wherein the rotary tool contacts the joint with an axial pressure force concurrently with rotationally engaging the first and second metal matrix composites.

8. The method according to claim 7, wherein an interface of the first and second metal matrix composites at the joint is subjected to pressure in the range of approximately 20-60% of the yield strength of the metal matrix composite material.

9. The method according to claim 8, wherein the joining portions of first and second metal matrix composite workpieces adjacent the joint are heated to a temperature between and including 400 to 1000 degrees Fahrenheit.

10. The method according to claim 1, wherein the portions of the first and second metal matrix composite workpieces in the plastic condition at the joint are not melted by the heating step.

11. The method according to claim 1, wherein the material in the fusion zone has a strength at least as great as base material of the first and second metal matrix composite workpieces.

12. The method according to claim 1, wherein the metal matrix composite workpieces are comprised of aluminum or aluminum alloy powder mixed with embedded particles of boron carbide.

13. The method according to claim 1, wherein the edges of the first and second metal matrix composite workpieces are abutted together at the joint.

14. A method for welding neutron absorbing materials together, the method comprising:
providing a first and second metal matrix composite workpiece each comprising material including boron carbide;
positioning edges of the first and second metal matrix composite workpieces together to form a joint;
frictionally heating joining portions of the first and second metal matrix composite workpieces at the joint to a plastic condition, wherein the joining portions are not melted by the frictional heating;
intermingling plastic material from the first and second metal matrix composite workpieces together at the joint; and
cooling the intermingled plastic material to a solid state forming a welded fusion zone comprised of material from the first and second metal matrix composite workpieces,
wherein the first and second metal matrix composite workpieces are fused together at the joint.

15. The method according to claim 14, wherein the first and second metal matrix composite workpieces are each configured as flat plates.

16. The method according to claim 15, wherein the edges of the first and second metal matrix composite workpieces are straight creating a joint having a linear shape.

17. The method according to claim 16, wherein the first and second metal matrix composite workpiece plates are arranged parallel to each other on opposing sides of the joint.

18. The method according to claim 16, wherein the first and second metal matrix composite workpiece plates are arranged at an angle to each other on opposing sides of the joint between 0 degrees and 180 degrees.

19. The method according to claim 14, further comprising before the frictional heating step: engaging the joining portions of the first and second metal matrix composite workpieces with a rotary tool; and rotating the rotary tool while maintaining engagement with the joining portions.

20. The method according to claim 19, wherein the rotary tool engages the joining portions of the first and second metal matrix composite workpieces with sufficient axial force to form the plastic condition in the joining portions.

21. The method according to claim 19 or 20, wherein the rotary motion tool includes a tool pin which enters and frictionally engages the first and second metal matrix composite workpieces at the joint during the heating step.

22. The method according to claim 14, wherein the metal matrix composite workpieces are comprised of aluminum or aluminum alloy powder mixed with embedded particles of boron carbide.

23. The method according to claim 14, wherein the joining portions of first and second metal matrix composite workpieces adjacent the joint are heated to a temperature between and including 400 to 1000 degrees Fahrenheit.

24. The method according to claim 19, wherein an interface at the joint is subjected to pressure in the range of approximately 20-60% of the yield strength of the metal matrix composite material by the rotary tool.

25. A method for welding neutron absorbing materials together, the method comprising:
providing a first and second metal matrix composite workpiece each comprising a neutron absorbing material;
providing a rotary tool having a head configured to engage the first and second metal matrix composite workpieces;
positioning edges of the first and second metal matrix composite workpieces proximate to each other to form a joint;
rotationally engaging the first and second metal matrix composite workpieces at the joint with the head of the rotary tool;
frictionally heating the first and second metal matrix composite workpieces at the joint to a plastic condition with the rotating head of the rotary tool, wherein the joining portions of the first and second metal matrix composite workpieces are not melted by the frictional heating;
intermingling plastic material from the first and second metal matrix composite workpieces together at the joint; and
cooling the intermingled plastic material to a solid state forming a welded fusion zone comprised of material from the first and second metal matrix composite workpieces;
wherein material of the first and second metal matrix composite workpieces at the joint are heated to a temperature between and including 400 to 1000 degrees Fahrenheit.

26-32. (canceled)
